(19) United States
(12) Patent Application Publication
(10) Pub. No.: US 2012/0265803 A1
(43) Pub. Date: Oct. 18, 2012

(54) PERSONAL CLOUD

(76) Inventors: Robert HA, Saratoga, CA (US); Jian-Jung Shiu, Taipei (TW); Mark Lee, Saratoga, CA (US); Philip Sheu, Campbell, CA (US); Yu Qing Cheng, San Jose, CA (US)

(21) Appl. No.: 13/450,245

(22) Filed: Apr. 18, 2012

Related U.S. Application Data
(60) Provisional application No. 61/476,669, filed on Apr. 18, 2011.

(51) Int. Cl. G06F 15/16

(52) U.S. Cl. 709/203

(57) ABSTRACT

A platform and service are provided that allow a user to have and use a personal, e.g. virtual, private cloud to which the user grants access to a defined group of users across multiple, different types of devices.

### CROSS REFERENCE TO RELATED APPLICATIONS

This patent application claims priority from U.S. provisional patent application Ser. No. 61/476,669, Splashtop Applications, filed Apr. 18, 2011, the entirety of which is incorporated herein by this reference thereto.

### BACKGROUND OF THE INVENTION

1. Technical Field

This invention relates generally to the field of cross-device communications. More specifically, this invention relates to a personal cloud used in cross-device communications.

2. Description of the Related Art

Mobile devices are proliferating at their fastest pace in history. Personal computers (PCs) were considered the main personal device that people used. However, such consideration is rapidly changing as people now own and use mobile devices such as but not limited to smart phones and tablets in addition to their PCs. As well, it is considered that time spent on and usages of mobile devices are exceeding that of PCs. One belief is that going forward, a family may own one or two PCs but tens of mobile devices among the family members. Still, an advantage of having and using a PC may be considered the computing power and storage of the PC. For example, people may continue to use a PC to run applications and store files, such as but not limited to documents, photos, and multimedia such as but not limited to video and music.

### SUMMARY OF THE INVENTION

A platform and service are provided that allow a user to have and use a personal, e.g. virtual, private cloud to which the user grants access to a defined group of users across multiple, different types of devices.

### BRIEF DESCRIPTION OF THE DRAWINGS

FIG. 1 is a sample UI of a home page of a primary user at the particular url of the personal cloud service; according to an embodiment;

FIG. 2 is a sample UI of a home page of a secondary user at the particular url of the personal cloud service; according to an embodiment;

FIG. 3 is a schematic diagram showing the high level structure of a personal cloud environment, according to an embodiment;

FIG. 4 is a schematic diagram showing a paradigm shift from a traditional remote desktop structure and service to a device interconnection structure and service, according to an embodiment; and

FIG. 5 is a block schematic diagram of a system in the exemplary form of a computer system according to an embodiment.

### DETAILED DESCRIPTION OF THE INVENTION

An embodiment provides a solution to a potential desire to access files and applications on a computing device, such as but not limited to a PC, which desire may continue to increase for the user as well as for his or her family, friends, or colleagues. Thus, one or more embodiments herein provide for such user a personal, e.g. virtual, private cloud for allowing a defined group of people or other end-users to access his or her applications and data. A platform and service are provided that enable the afore-mentioned functionality and usage.

### User Experience

One or more embodiments can be understood with reference to the following example. Consider a user, herein referred to as Robert, as an example end user. It should be appreciated that using a single individual is by way of example only and is not meant to be limiting. As another example, an automated processor controlled by artificial intelligence, for example, may also perform one or more of the steps described hereinbelow.

Continuing with the example, assume that Robert has one PC and assume such PC resides at his home. In accordance with an embodiment, Robert may store a variety of content, applications, files, and other data, such as but not limited to family documents, photos, media, and music on such PC.

Further according to the example, assume each of Robert's family members has one or more client devices that is in communication over a network with such PC, such as but not limited to a tablet or a smart phone. It is contemplated that at any time, any of Robert's family members may want to access content on such PC from such devices. By way of illustration, examples include but are not limited to the following: showing on his or her tablet or smart phone a video clip from Robert's PC; downloading a document to his or her tablet or smart phone from Robert's PC; sharing for example by way of social media, or for example from a social network by Splashtop Inc. such that such shared content is only with a few people that are allowed access into Robert's personal cloud as discussed below, a photo or even a slide show from Robert's PC with a limited set of family or friends that are in communication with the tablet or smart phone; or demonstrate on the tablet or smart phone a new game that is hosted on Robert's PC. It should be appreciated that the particulars are by way of example only and are for the purposes of understanding and are not meant to be limiting.

Further, an embodiment allows such family member to achieve any of the afore-mentioned tasks without needing to upload any of such data to another and different third party service.

Continuing with the example and in accordance with an embodiment, to allow any of the afore-mentioned tasks, Robert registers with a personal cloud service. At such personal cloud service, Robert registers for an account and password. At such personal cloud service, Robert may select his own url. For example and in accordance with an embodiment, Robert may register for robert.splashtop.com. Robert may be considered an administrator of his personal cloud platform and service.

In accordance with an embodiment, after registering for his url, Robert installs on his PC a corresponding client/server component that may be in communication with their personal cloud service. It should be appreciated that in an embodiment, both a server component and a client component are provided such that data is shared both ways to and from the PC or any device. Thus, from Robert's point of view, an initial setup is now completed.

In an embodiment, when Robert desires to access any of the application, files, or other content on his PC from any other device, Robert may use a browser at such other device and enter Robert's url. One at the url, Robert may sign-in with his password.

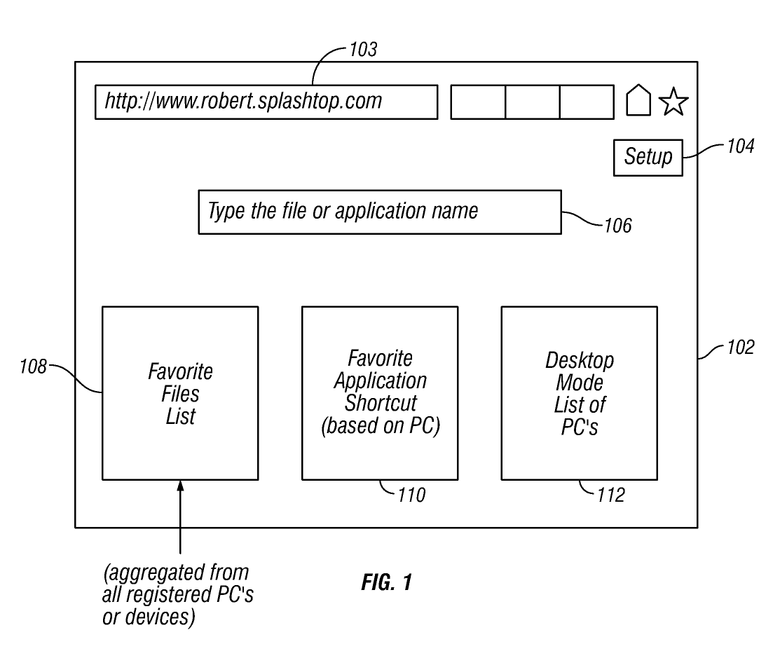

In an embodiment, at Robert's url, Robert may see a default user interface (UI) at which Robert can perform one or more functions. An embodiment can be understood with reference to FIG. 1. FIG. 1 is a sample home page 102 at the particular url 103 of the personal cloud service.

With reference to FIG. 1, some functions of this page and in accordance with an embodiment are described as follows:
Setup 104: Setup 104 navigates Robert to a logical component where Robert may configure which folders or other content are accessible by others. As well, Robert may configure whether a password is required by others. Further, Robert may configure a default condition which may include all content shared or all content locked. It should be appreciated such particular examples of setup configurations are meant to be exhaustive.
Search box 106: At search box 106, Robert or any of his family/friends who have logged in may type a search string, such as a file name, application name, or email properties, e.g. sender/receiver/subject/attachment, in search box 106 to perform a search related to such search string on Robert's PC for the purposes of obtaining the search results. It should be appreciated that such particular examples of search entries are by way of example only and are not meant to be limiting.
   In an embodiment, the user may select how they want to handle the search results. As an example, in an embodiment, the user may select whether to open the result remotely, download the result, send the result, or share the results.
Favorite Files List 108: Favorite files list 108 contains a list of filenames, which are presumably favorite files. In an embodiment, such filenames may also be one or more shortcuts to open or download a particular file from a defined PC.
   It should be appreciated that in an embodiment, such list of files may be an aggregated list of files where one or more files are from other devices that are registered with the personal cloud service at url 103, such as for example with other PCs (not shown).
Favorite Application List 110: Favorite application list 110 contains a list of applications which are presumably favorites and which, when selected, are each a shortcut to open that particular application on a PC registered with url 103, such as Robert's PC.
Desktop Mode 112: Desktop mode 112 contains a lists of the devices, such as PCs, which are registered with the personal cloud service for url 103. In an embodiment, desktop mode 112 may contain a device whether such device is online or offline.
   In an embodiment, a user may wake up a particular device if such device is in sleep mode. In an embodiment, when such device is selected, a remote desktop for such device is opened. In accordance with an embodiment, such remote desktop may be opened using one or more embodiments described in currently co-assigned U.S. patent application Ser. No. 13/165,469, titled, “Remote Server Environment”, filed Jun. 21, 2011, the entirety of which is incorporated herein by this reference thereto.

In an embodiment, to allow other users, such as members of a family, to access content such as applications or files on the personal cloud, the primary user, which in this example is Robert, shares the url with such other users.

In an embodiment, some content on the personal cloud may be accessible without requiring entering a password.

In an embodiment, the primary user, which may also be thought of as an administrator, such as Robert, may also share a password to other users, such as his family members, in the case when access to particular content, such as applications or files, requires a password.

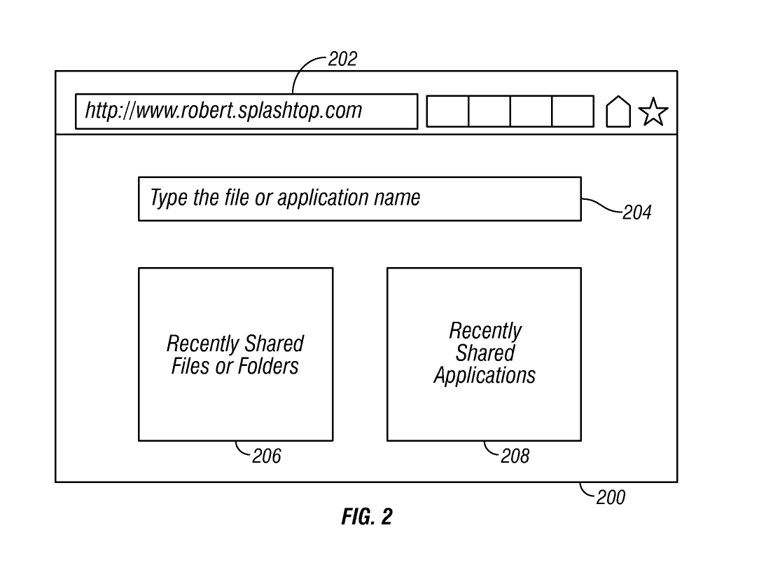

In an embodiment, upon login from a browser on any second device, a second user, such as for example a family member is taken to a particular UI page. An example of such particular UI 200 is shown in FIG. 2 and an embodiment can be understood with reference to FIG. 2. FIG. 2 shows that the secondary user is at the url for Robert, e.g. http://robert.splashtop.com. Similarly to the UI of FIG. 1, a search box 204 is provided in which the user may type in search criteria, e.g. a file name or an application name and so forth. In this particular sample UI, a list of recently shared files or folders 206 is provided. It should be appreciated that such shared files may be from Robert's PC as well as all the other devices that are part of this personal cloud, such as a phone and tablet, anything connected and setup to be part of this personal cloud. It should be appreciated that entries may represent files or folders that were shared by members other than the user who is logged in. For example, perhaps a particular folder of photos from a recent family vacation has been accessed recently many times by family members. Then, a different family member logging in for the first time since the vacation may see in such list 206 that there is a folder of photos from the vacation, because they have been recently shared. Similarly, a list of recently shared applications 208 is provided. Examples of such applications may include but are not limited to games that a family member recently played, a fitness application that was updated with a family member workout and/or results, etc. It should be appreciated that the particulars are by way of example only and are not meant to be limiting.

It should be appreciated that in an embodiment, secondary users, such as for example family members of Robert may not have access to some of the functionality to which the owner, e.g. Robert, has access. For example, secondary users may not be able to set access privileges to other users for particular files and folders. As well, in an embodiment, such secondary users may have access to a subset of content, e.g. files or applications, which have been configured by Robert to share. For example, Robert may have folders with content that are about his children, the access to which Robert has configured to be for him and his wife only.

In an embodiment, secondary users may have access to content in a variety of ways. For example, such secondary users may remotely access files or may select to download such files. Thus, for example, a secondary user may see a large file on Robert's PC and, instead of downloading such a large file on his tablet, uses an application on Robert's PC to open and, thus, view the file on Robert's PC. As another example, the same user using his cell phone may see a photo on Robert's PC and desire to have a copy of that photo. Thus, the user may download such photo from Robert's PC to his cell phone.

In an embodiment, a mechanism determines the type of the device that is requesting access to a particular file. Then, depending on the type of device, an embodiment opens the appropriate application with the optimized configuration in order to provide the device with a good experience, such as for screen resolution, screen size, device input methods, gestures, and so forth. One embodiment is described in further detail hereinbelow.

### Exemplary Platform and Service

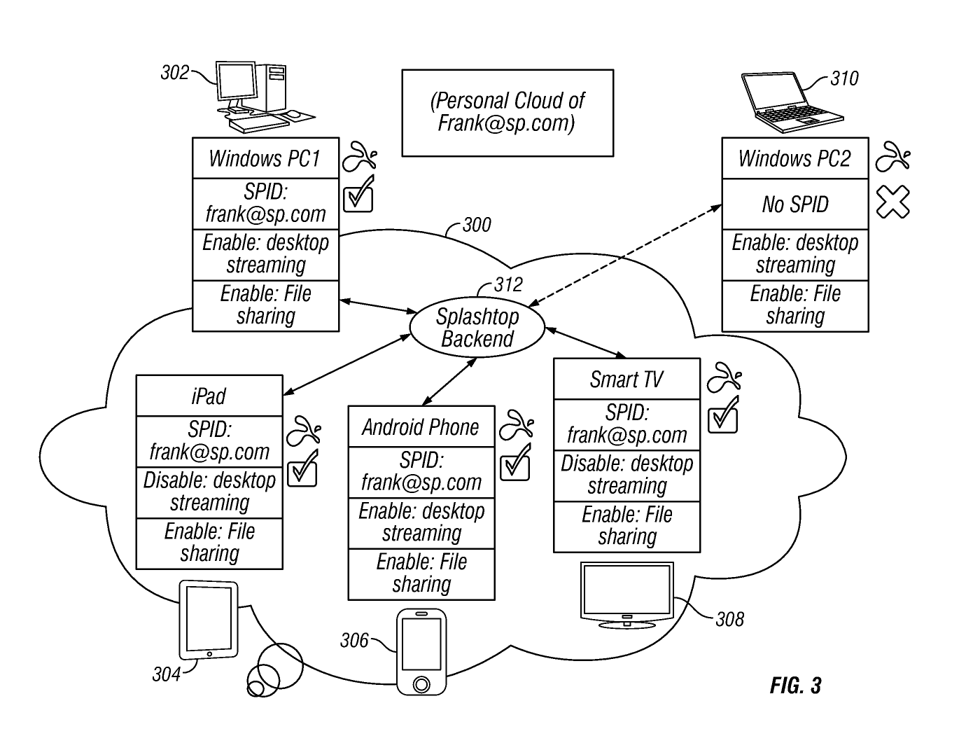

An embodiment provides structure and functionality for a personal cloud experience by providing the following two high level components, namely, Cloud Component and PC/Device Component. An embodiment can be understood with reference to FIG. 3. FIG. 3 is a schematic diagram showing the high level structure of a personal cloud environment, according to an embodiment. Also, for illustrative purposes, the particular details shown in FIG. 3 are an example of a personal cloud environment 300 for a person named, Frank, having the url for his personal cloud be Frank@sp.com. It should be appreciated that throughout the discussion about FIG. 3, the details are meant by way of example only and are not meant to be limiting.

Personal cloud 300 has four devices that are in communication therewith, namely, a Windows PC1 302; an iPad 304; an Android Phone 306; and a Smart TV 308. It should be appreciated that a second PC, Windows PC2 310 is shown to be optionally in communication with personal cloud 300. It should be appreciated that importantly embodiments are not limited to a single central PC in this personal cloud concept. Embodiments may have multiple PCs that are configured to be networked and sharing.

As is illustrated in FIG. 3, Windows PC1 302, iPad 304, Android Phone 306, and Smart TV 308 are each logged into Personal Cloud 300 with specific ID, frank@sp.com. In contrast, Windows PC2 310 is not currently logged in, but is shown via the dotted line that is may login to Personal Cloud 300 at another point in time. As long as a device has a PC/Device Component, e.g. a Splashtop node program, installed and is logged in with SPID, the device is in communication with and considered to be attached to this personal cloud, e.g. personal cloud 300. In an embodiment, Streamer is the server component, e.g. available for PC/Mac computers. However, such server component may be provided for phones/tablets and other devices as well. The client application receives the streamer information. In an example implementation, clients may be the mobile devices and PC/Mac computers. However, it should be appreciated that in accordance with one or more embodiments, all devices support both streamer and client applications such that sharing is in both directions and with all devices.

In an embodiment, four usage models, which may be used together or separately, are provided, as follows:
File Transfer/Sharing. The user can see files on the devices in his personal cloud, rather than client-streamer file sharing.
Remote Desktop. The user may have access to remote desktop functionality from any devices in his personal cloud. For example, it may be powerful when a user has a TV node or an Android tablet node in his personal cloud.
Viral/Sharing. The users may invite each other, e.g. friends or family, to form a bigger cloud, yet still centered on a single person or family. In addition, the data is stored in a person's system, not on an unknown network in a data center. It may be quite powerful to form a family cloud to share photos and music, for example.
Enterprise. From an enterprise perspective, IT management may be redefined in a new view. In the embodiment, the IT department may need only to manage employees' personal clouds as a unit by allowing authenticated devices into the personal cloud of the IT manager.

Following is a detailed discussion about the above-mentioned high level components in accordance with one or more embodiments.
Cloud Component 312. Cloud component 312 resides remotely from any of the devices on a different device that may be considered a server. Cloud component provides functionality for any of the devices to be in communication with one another.
   In the embodiment, cloud component 312 contains three sub-components (not shown), namely, User Profile and Presentation Layer, Connection Broker, and Relay Infrastructure, each of which is described in further detail below.
      User Profile and Presentation Layer is a component which allows a user to have and set a profile and also is configured for determining how content and functionality are to be presented. For example, in this embodiment, User Profile and Presentation layer includes but is not limited to the UI described in the previous figures. User Profile and Presentation Layer provides the functionality that allows users to perform the functions described in previous paragraphs, such as but not limited to performing search based on various criteria and displaying and sorting the results.
      Connection Broker is a component which manages and facilitates how each registered device connects to Cloud Component 312. For the purposes of discussion herein, a registered device is a device from which content such as files and applications may be shared. In the example above, Robert's PC is a registered device. It should be appreciated that there may be more than one registered device. For purposes of discussion herein, a registered device is a device that has been authorized and connected to a personal cloud account. In one embodiment, such registration process may only entail using that device to login to the account. In another embodiment, there may be more authorization requirements, such as for example an email to the account email where a user of the email account needs to click on a link in the email to complete the authorization. As in the example above and as shown in FIG. 1, Robert may have registered more than one device, each of which are listed in desktop mode list of PCs 112.
         It should be appreciated that an embodiment of Connection Broker can be found in products that are used by Splashtop Inc. Connection Broker are one or more account management servers running processes in a “cloud”. No data is stored on such cloud, however such processes manage the account devices for connecting to each other.
         In an embodiment, Connection Broker caches files and applications lists based on the user's ID and registered PC or devices. For example, Robert's favorite files list 108 may be cached based on registration information about Robert's registered PC. As another example, the recently shared files or folders list 206 may be cached based on the user ID of the person who just logged into Robert's personal cloud url 103. By caching files and applications lists, an embodiment does not require performing a full search every time such lists are populated. As well, each time a connection is made to Cloud Component 312 by any device, an embodiment synchronizes such cached list.
         An embodiment collects information about a device that has just connected to Cloud Component 312, such as but not limited to device type and hardware/software information and passes such collected information to a PC/Device Component (“Streamer”), described in further detail hereinbelow. By sending information about the device to PC/Device Component, PC/Device Component may optimize the end-user device experience including but not limited to delivering an appropriate application and configuration to the device.
      Relay Infrastructure is a component which comprises relay servers which are used in data centers to “bridge” device connections to each other. For example, typically, on a local network a client application and streamer application talk directly to each other. A relay server may help these devices find each other and establish a connection through the relay server. Thus, for example, a 3-point communication is with the relay in the middle versus a 2-point communication with no relay on a local network.
         It should be appreciated that an embodiment of Relay Infrastructure can be found in products that are used by Splashtop Inc.
         In an embodiment, Relay Infrastructure is configured to deliver files or streaming content from the remote devices, such as but not limited to remote desktops and remote applications from and to any device, including firewall crossing.
PC/Device Component (also referred to herein as “Streamer”). For purposes of discussion herein, PC/Device Component (not shown) is assumed to reside in Windows PC1 302.
   Streamer Functionality
      It should be appreciated that an embodiment of Streamer functionality can be found in products that are used by Splashtop Inc. and described in currently co-assigned U.S. patent application Ser. No. 13/165,469, titled, “Remote Server Environment”, filed Jun. 21, 2011, the entirety of which is incorporated herein by this reference thereto.
   Components for adequate streaming performance of the video/audio. In an embodiment, HTML5 is used for such access and performance. For purposes of discussion herein, HTML5 is a fifth generation of the standard HTML. In an embodiment, users and/or their family members may use any browser that supports HTML5 to access Personal Cloud 300.
   Access Control Component. For purposes of discussion herein, Access Control Component provides but is not limited to the following functionality:
      Access Control Component uses the profile definition configured by the user, e.g. Robert, in Cloud Component 312, e.g. Splashtop Cloud, and determines which content, such as files, folders, and applications, may be accessed by other users, such as family members. After such determination and in response to particular user requests, Access Control Component provides appropriately filtered results. For example, Access Control Component may provide remote access and search results that have been filtered to only the allowed files, applications, or folders. For purposes of discussion herein, by allowed is meant those files, applications, or folder to which the primary user granted access.
      Further, in accordance with an embodiment, depending on the content type, e.g. file type, Access Control Component is configured to select an appropriate application in which to open such content.
      In an embodiment, Access Control Component is configured for indexing content on the registered device, such as indexing files and folders on Robert's PC, and configured for synchronizing such indexes with a cached version of the index on Cloud Component 312.
   Application and Control Component. For purposes of discussion herein, Application and Control Component provides but is not limited to the following functionality:
      In an embodiment, dedicated applications for remote access including but not limited to add-on's are provided. For example, for photo sharing, an embodiment provides a dedicated application that allows viewing of photos and slideshows without requiring the user to use the user interface, e.g. 200, to have to access the desktop to access other files/data on the PC. Such dedicated application may be locked down applications. Thus, an embodiment provides a dedicated UI to the user, is configured to transcode content and to stream such transcoded content to the user at Windows PC1 302 remotely.
      Further, regarding office documents, such as but not limited to Windows® Office documents, an embodiment is configured such that a user may open a local Office application or may open a particular file by using an Office application via a service provided by Cloud Component 312, depending on the configurations, preferences, etc., of the user.

### Extensibility

It should be appreciated that in the example discussed above, only one PC, Windows PC1 302, was referenced. However, referencing only one PC was to simplify the explanation of structure and functionality of one or more embodiments and was not meant to be limiting. Typically, a user or family has a plurality of PCs or servers. An embodiment provides an architecture that abstracts the PC layer and aggregates the functions across a plurality of PCs. For example, when a user performs a search function, instead of searching one PC, a component is provided (not shown) that is configured to perform a search on the registered PCs. Further, an embodiment is configured to provide the results of the search in a combined, sorted list. For example, a family may have one personal cloud in which all devices owned by family members are registered. Thus, in this example, any member on any device may have access to photos on any other registered device other than his or her own device.

Further, for purposes of discussion herein, the single registered device was the PC, e.g. Windows PC1 302, as the host. However, it should be appreciated that as mobile devices gain computing power and storage, the same usage model may be applied to mobile devices as well. In such embodiment, each device may be considered a “server” in the personal cloud.

### Symmetrical Structure

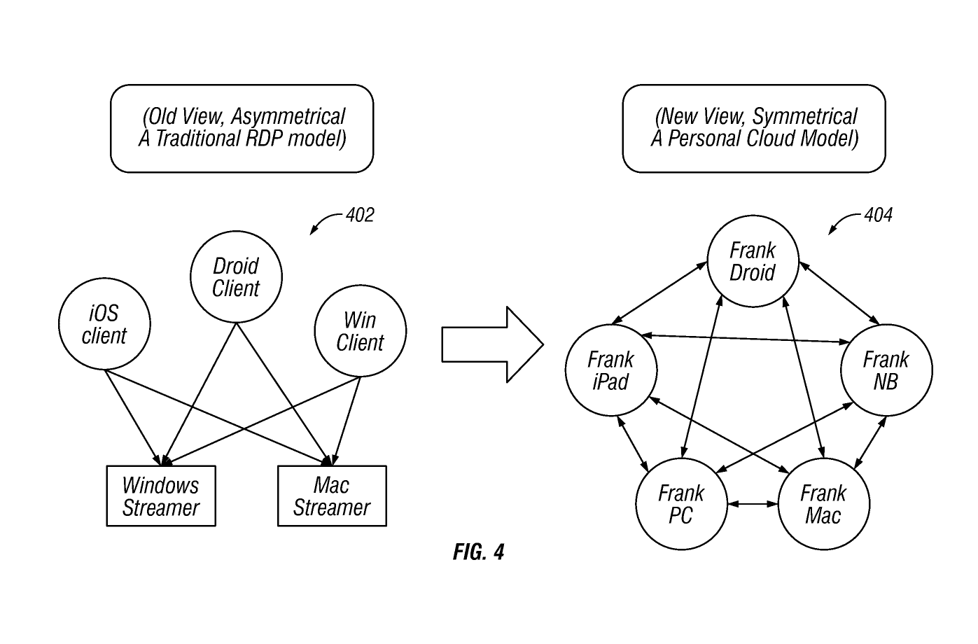

Thus, in view of the discussion above, it should be appreciated that one or more embodiments provide a symmetrical structure as well as functionality. An embodiment can be understood with reference to FIG. 4. FIG. 4 is a schematic diagram showing that one or more embodiments results in a paradigm shift from a traditional remote desktop structure and service 402 to a device interconnection structure and service 404.

### An Example Machine Overview

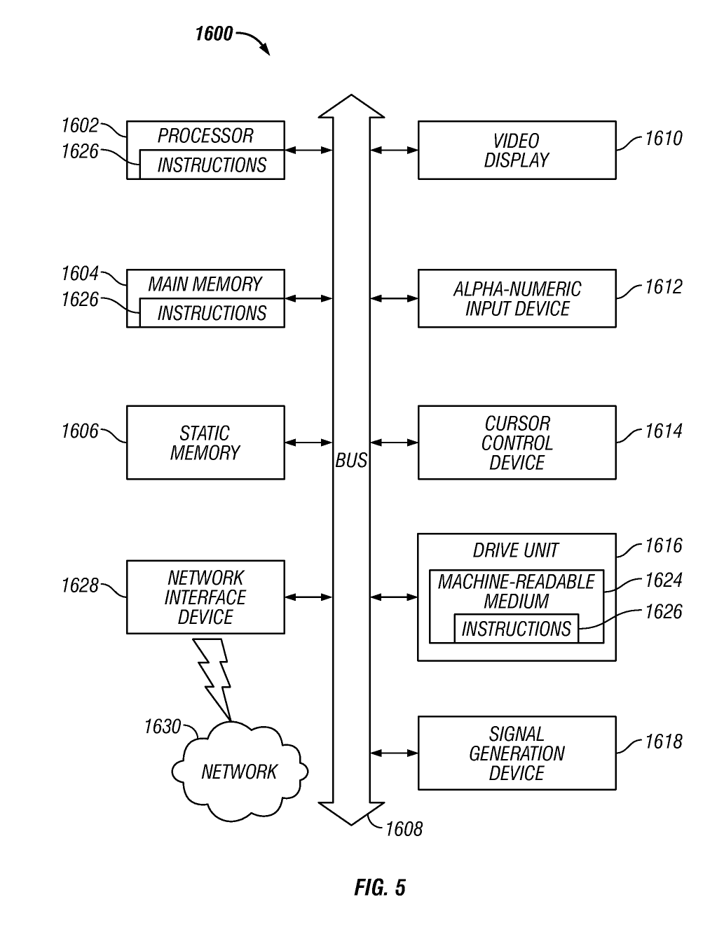

FIG. 5 is a block schematic diagram of a system in the exemplary form of a computer system 1600 within which a set of instructions for causing the system to perform any one of the foregoing methodologies may be executed. In alternative embodiments, the system may comprise a network router, a network switch, a network bridge, personal digital assistant (PDA), a cellular telephone, a Web appliance or any system capable of executing a sequence of instructions that specify actions to be taken by that system.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1620.

The disk drive unit 1616 includes a machine-readable medium 1624 on which is stored a set of executable instructions, i.e. software, 1626 embodying any one, or all, of the methodologies described herein below. The software 1626 is also shown to reside, completely or at least partially, within the main memory 1604 and/or within the processor 1602. The software 1626 may further be transmitted or received over a network 1628, 1630 by means of a network interface device 1620.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for providing a personal cloud experience, comprising:
a cloud component at a server for providing communication services to a first computing device, including being configured to allow said first computing device to register with said cloud component, said cloud component configured with:
a user profile and presentation layer processor configured for providing user interfaces (UIs) to an end-user for accessing content on said first computing device;
a connection broker processor configured for managing and facilitating information about said first computing device; and
a relay infrastructure processor configured for delivering said content to a second computing device;
a streamer component at said first computing device for providing to said second computing device access to content at said first computing device, said streamer components configured with:
a streamer functionality processor configured for streaming multimedia;
an access control component processor configured for using predefined profile information to determine which content on said first computing device to allow said second computing device to access; and
an application and control component processor configured for providing support for one or more dedicated applications and add-on's without requiring said browser to be used.

2. The apparatus of claim 1, wherein said UIs allows said end-user to search content at said first computing device based on various criteria, display search results, and allow said end-user to sort said displayed search results.

3. The apparatus of claim 1, wherein said connection broker processor is configured for caching lists of content on said server, wherein the content in said lists represent corresponding content on said first computing device.

4. The apparatus of claim 1, wherein said connection broker processor is configured for collecting information about said first computing device, said information comprising type of device and hardware and software information, and is configured for passing said collected information to said streamer component at said second computing device to cause said second computing device to be optimized with respect to handling content from said first computing device.

5. The apparatus of claim 1, wherein said delivered content comprises files, folders, and applications.

6. The apparatus of claim 1, wherein said relay infrastructure processor is configured to deliver said content across firewalls.

7. The apparatus of claim 1, wherein said streamer component is loaded on both said first computing device and said second computing device.

8. The apparatus of claim 1, wherein said predefined profile information determines:
which files, folders, and applications are accessed by other computing devices and provide appropriate filtered access; and
which appropriate application to use to open said determined files, folders, and applications.

9. The apparatus of claim 1, wherein said access control component processor is configured for indexing content on said first computing device and for synchronizing with a corresponding index on said cloud component.

10. The apparatus of claim 1, wherein said application and control component processor is further configured for transcoding content and to stream said transcoded content.

11. The apparatus of claim 1, wherein more than one computing devices are registered with said cloud component and host said streamer component such that each said registered computing device has access to content on any other said registered computing device.

12. The apparatus of claim 1, wherein at least one of said user interfaces is configured to include any of:
provide setup configurations;
provide a search box;
provide a favorite files list;
provide a favorite application list; and
provide a list of registered computing devices.

13. A computer-implemented method for providing a personal cloud experience, comprising the steps of:
providing communication, by a cloud component at a server, services to a first computing device, including allowing said first computing device to register with said cloud component, said cloud component configured with:
a user profile and presentation layer processor configured for providing user interfaces (UIs) to an end-user for accessing content on said first computing device;
a connection broker processor configured for managing and facilitating information about said first computing device; and
a relay infrastructure processor configured for delivering said content to a second computing device;
providing, by a streamer component at said first computing device, to said second computing device access to content at said first computing device, said streamer components configured with:
a streamer functionality processor configured for streaming multimedia;
an access control component processor configured for using predefined profile information to determine which content on said first computing device to allow said second computing device to access; and
an application and control component processor configured for providing support for one or more dedicated applications and add-on's without requiring said browser to be used.

14. A computer-readable storage medium storing one or more sequences of instructions for providing a personal cloud experience, which instructions, when executed by one or more processors, cause the one or more processors to carry out the steps of the computer-implemented method of claim 13.
